(19) United States
(12) Patent Application Publication
(10) Pub. No.: US 2012/0199609 A1
(43) Pub. Date: Aug. 9, 2012

(54) WALL-MOUNTED METERING DISPENSER

(75) Inventor: Horst Schwenkenberg, Halstenbeck (DE)

(73) Assignee: CSD COSMETIC-SYSTEMS DEVELOPMENT UGMBH, Hamburg (DE)

(21) Appl. No.: 13/501,307

(22) PCT Filed: Oct. 13, 2010
(86) PCT No.: PCT/EP2010/006249

§ 371 Date: Apr. 11, 2012

(30) Foreign Application Priority Data
Oct. 13, 2009 (DE) 102009049261.5

(51) Int. Cl. B67D 7/06

(52) U.S. Cl. 222/181.3

(57) ABSTRACT

A wall-mounted metering dispenser (1), including a wall mounting (2) having two retaining arms (3, 4), between which a refill unit (5) is detachably held, the refill unit having a storage container (6) and a dispensing device, the dispensing opening (7) of which is directed downward. The retaining arms (3, 4) can be detached from one another and/or moved relative to one another between a release position and a retaining position, and wherein the removal device can be actuated by applying pressure to the storage container (6), at least a portion of the container wall of which is made of a resilient material. The wall-mounted metering dispenser (1) is characterized in that the refill unit (5) is movably held in the wall mounting (2) and can be moved between a stand-by position and an actuated position, and the wall mounting (2) is provided with at least one actuation protrusion (9), which in the actuated position acts on the container wall at least in the resilient portion thereof such that the removal device is actuated. The wall-mounted metering dispenser (1) is particularly easy to use, even when the user has very dirty hands, without drastically soiling the periphery of the storage container (6) in the process.

### BACKGROUND

The invention relates to a wall-mounted metering dispenser with a wall holder, which has two retaining arms, between which a refill unit is retained in a releasable manner, which refill unit comprises a storage container and a dispensing device, which has its dispensing opening oriented downward, wherein the retaining arms can be released from one another and/or moved relative to one another between a release position and a retaining position, and wherein the dispensing device can be actuated by pressure activation of the storage container, which has at least one sub-region of its container wall produced from elastic material.

EP 0 530 789 B1 already discloses a wall-mounted metering dispenser of the type mentioned in the introduction, with a C-shaped holder, of which the free end regions form retaining arms, between which a refill unit is retained in a releasable manner, the refill unit comprising a storage container and a dispensing device, which has its dispensing opening oriented downward. In order for it to be possible for the storage container to be removed from the holder and exchanged if required, one of the retaining arms is configured as a retaining sleeve which engages around the storage container in certain regions, is connected in a releasable manner to the holder, and is secured thereon by means of an anti-theft device. Since the storage container is retained in the holder in an exposed state, and such that it can be subjected to pressure, and since the outlet valve can be opened by pressure activation of the container wall of the storage container, the fluid stored in the storage container can be removed by virtue of the compliant container wall being subjected to manual pressure.

If the user, however, has very dirty hands, there is the problem that manual actuation of the storage container may also result in the container wall becoming heavily soiled, and this can make it impossible for subsequent users to actuate the prior-art wall-mounted metering dispenser straightforwardly. In accordance with the latest hygiene-related findings, it should also be the case that one should touch by hand as little as possible objects which have already been touched by a lot of other, possibly unknown people. If these findings are related to the present technical field, then a wall-mounted metering dispenser should, as far as possible, not be actuated by hand.

U.S. Pat. No. 3,926,347 has already disclosed a wall-mounted metering dispenser which can be fastened on a wall by means of a wall holder. The wall holder has two retaining arms, between which a storage container is retained in a releasable manner. A box-like closure cover is retained in a pivotable manner on the wall holder and covers over the wall holder and the storage container, which is mounted in the wall holder. The interior of the closure cover is provided with an actuating protrusion which, upon pressure activation of the closure cover, is pressed into the elastic container wall of the storage container such that some of the contents stored in the storage container are forced out of the container interior. The container opening of the storage container here butts against the closure cover such that the container opening and a dispensing opening, which is provided in the closure cover, are aligned with one another in a pivoting position of the closure cover and the contents forced out of the storage container can exit.

Since the closure cover covers over the storage container, it is not possible to see into the storage container, or to see the contents stored therein, and it is also the case that the visible container wall of the storage container cannot be utilized, for example, as an advertising surface. Since the storage container does not have a dispensing valve, and since dispensing is controlled instead via the dispensing opening provided in the closure cover, changeover of the contents used is not readily possible, and it is also made much more difficult to keep, in particular, the region of the dispensing opening hygienic.

### SUMMARY

It is, therefore, an object of the invention, in particular, to provide a wall-mounted metering dispenser of the type mentioned in the introduction which is in line with the latest hygiene-related findings.

This object is achieved according to the invention, in the case of the wall-mounted metering dispenser of the type mentioned in the introduction, in particular in that the refill unit is retained in a movable manner in the wall holder and can be moved between an actuating position and a standby position, and in that provided on the wall holder is at least one actuating protrusion, which, in the actuating position, acts on the container wall, at least in the elastic sub-region thereof, such that the dispensing device is actuated.

In the case of the wall-mounted metering dispenser according to the invention, the refill unit is retained in a movable manner in the wall holder and can be moved between a standby position and an actuating position, in which actuating position the medium stored in the storage container can flow out, for example, into a user's hands. The wall-mounted metering dispenser here, on its wall holder, has at least one actuating protrusion, which, in the actuating position, acts on the rear container wall, directed toward the wall holder, at least in an elastic sub-region, such that the dispensing device is actuated. The user can thus also move the storage container on one side against the actuating protrusion by applying pressure using the elbow or the back of the hand, in order to move the dispensing device, which has its dispensing opening oriented downward, from its standby position into its actuating position, and therefore, even if the user's hands are very dirty, soiling of the container wall can be avoided.

A particularly straightforward and advantageous embodiment according to the invention provides that the refill unit is retained in a pivotable manner on at least one retaining arm. In the case of such an embodiment, in which the refill unit is mounted in a pivotable manner in the holder, it is possible to dispense with any complicated sliding guide or the like.

In order, nevertheless, for it to be possible for the storage container to be guided reliably from its standby position into the actuating position, it is advantageous if at least one retaining arm can be moved from a starting position, preferably counter to a restoring force, into an actuating position, in which it is in close proximity to the at least one actuating protrusion.

The storage container can be readily removed from the wall holder and exchanged for another storage container if required if at least one retaining arm is retained in a movable and/or releasable manner on a sub-region of the wall holder which is mounted at a fixed location on a wall.

In order for it to be possible to rule out unauthorized manipulation of the storage container and of the contents stored therein, it is expedient if the retaining arm, which is retained in a movable and/or releasable manner on the wall holder, can be secured thereon by means of an anti-theft device.

A preferred embodiment here, which comprises an anti-theft device which is of straightforward design, but is nevertheless effective, provides that the retaining arm, which is retained in a movable and/or releasable manner on the wall holder, is retained thereon by means of a latching connection, which latching connection can be unlatched by means of a preferably pin-like release tool, wherein the release tool can be positioned on the latching connection through an appropriately shaped plug-through opening in the outer wall of the wall holder.

A development according to the invention provides that the dispensing device has a dispensing valve with a valve body, on which a spring clip acts, which spring clip is in close proximity to at least one inner side of the container wall, or butts against the same, such that pressure activation which deforms the container wall can be converted into a longitudinal movement of the valve body from the closing position into the open position of the valve.

So that even a slight tilting movement of the storage container in the direction of the actuating protrusion can be converted into an opening movement of the dispensing device, it is advantageous if the actuating protrusion acts on the container wall in the region of its outer side which is located opposite the spring clip. This region of the container wall constitutes the pressure point which is optimum for actuation of the dispensing valve, and reliably ensures the functional capability of the dispensing valve.

The storage container can be mounted in the holder in a reliable and firm, and nevertheless movable, manner if the storage container has a container neck which can be closed preferably by means of a closure cap, and if the retaining arm adjacent to the container neck has an appropriately shaped and/or annular sub-region engaging around the same.

In order for it to be possible to see the remainder of the stored fluid in the storage container and to assess the filling state of the wall-mounted metering dispenser, it is advantageous if the storage container, in the region of the container neck, and/or the closure cap are/is produced from a see-through and/or transparent plastics material. If the storage container, in the region of the container neck, and possibly also the closure cap are produced from a see-through and/or transparent plastics material, the remainder of the stored fluid collecting in the downwardly oriented closure cap is clear to see.

Further features of the invention can be gathered from the following description of an exemplary embodiment according to the invention in conjunction with the claims and the drawing. The individual features may be realized on their own or in combination in any embodiment according to the invention.

### BRIEF DESCRIPTION OF THE DRAWINGS

In the drawing:

FIG. 1 shows a side view of a wall-mounted metering dispenser which is intended for liquid or pasty filling media and has an angled wall holder, of which the free end regions form retaining arms, between which a refill unit comprising a storage container and dispensing device is retained, wherein the dispensing opening of the dispensing device, which projects into the container cap, is oriented downward,

FIG. 2 shows the wall-mounted metering dispenser from FIG. 1 in a lateral longitudinal section through section plane II-II in FIG. 5,

FIG. 3 shows a wall-mountable constituent part of the wall holder of the wall-mounted metering dispenser shown in FIGS. 1 and 2,

FIG. 4 shows a further constituent part of the wall holder of the wall-mounted metering dispenser shown in FIGS. 1 to 3,

FIG. 5 shows a front view of the wall-mounted metering dispenser from FIGS. 1 to 4, wherein the wall-mounted metering dispenser has a droplet-form storage container, and

FIG. 6 shows a wall-mounted metering dispenser which is comparable in functional terms with FIGS. 1 to 5 and has a triangular storage container.

### DETAILED DESCRIPTION OF THE PREFERRED EMBODIMENTS

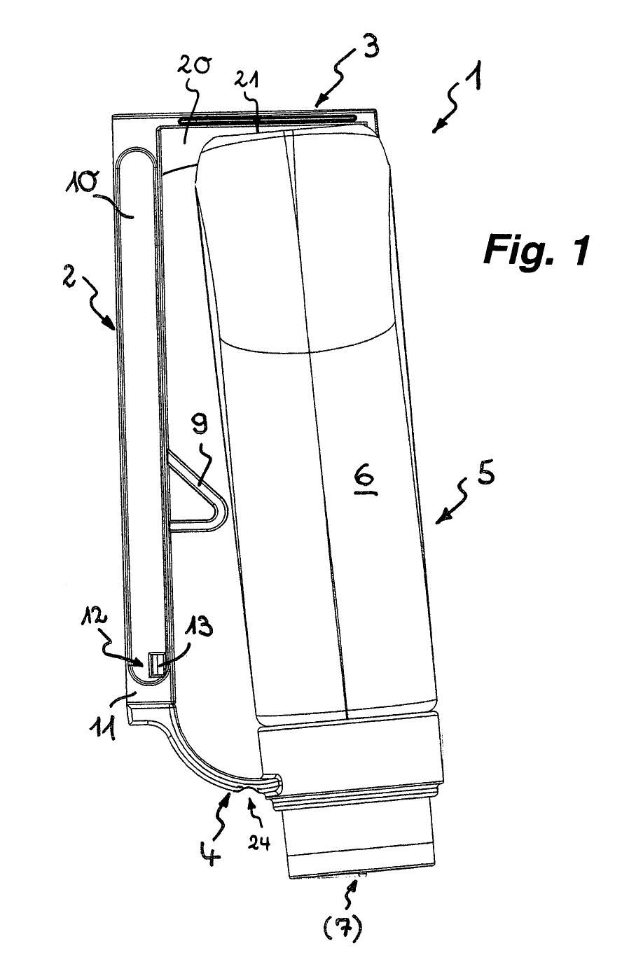

FIGS. 1, 2, 5 and 6 illustrate a wall-mounted metering dispenser 1 which is intended for liquid or pasty filling media. The wall-mounted metering dispenser 1 has a wall holder 2, which has two retaining arms 3, 4, between which a refill unit 5 is retained in a releasable manner. The refill unit 5 comprises a storage container 6 and a dispensing device, which has its dispensing opening 7 oriented downward. In order for it to be possible to remove the refill unit 5, comprising the storage container 6 and dispensing device, and exchange it, if required, for a full refill unit 5, or one filled with some other filling medium, the retaining arms 3, 4 are configured such that they can be moved relative to one another between a release position and a retaining position and/or—as is the case here—such that they can be released from one another.

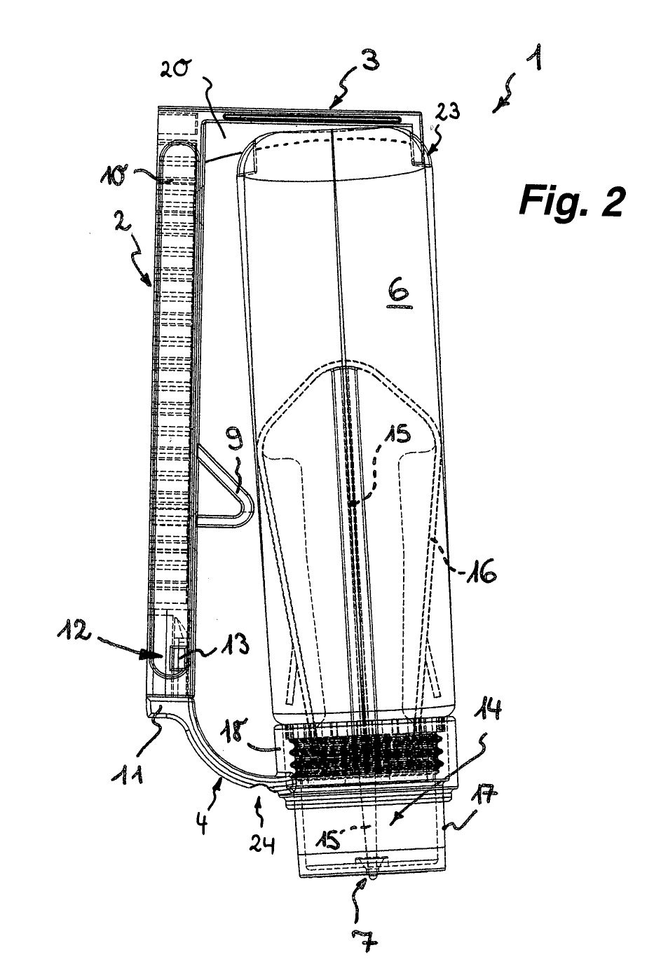

It can be seen in FIG. 2 that the dispensing device can be actuated by pressure activation of the storage container 6, which has at least one sub-region of its container wall produced from elastic material. For this purpose, the refill unit 5 is retained in a movable manner in the wall holder 2 and can be moved between the standby position, which is shown in FIGS. 1 and 2, and an actuating position, in which the dispensing device is located in its open position. For this purpose, the wall-mounted metering dispenser 1 has, on its wall holder 2, an actuating protrusion 9, which, in the actuating position, acts on the container wall, at least in the elastic sub-region thereof, such that the dispensing device is actuated. The user can thus also move the storage container 6 against the actuating protrusion 9 by applying pressure using the elbow, in order to move the dispensing device, which has its dispensing opening 7 oriented downward, from its standby position into its actuating position, and therefore, even if hygiene measures are in place or even if the user's hands are very dirty, soiling of the container wall can be avoided.

It is clear from a comparison of FIGS. 1 to 6 that the refill unit is retained in a pivotable manner at least on the upper retaining arm 3. The lower retaining arm 4, in contrast, can be moved from a starting position, counter to the restoring force of the elastic material of the wall holder 2, into an actuating position, in which this retaining arm 4 and that sub-region of the refill unit 5 which is enclosed by it are in close proximity to the actuating protrusion 9.

On the upper retaining arm 3, a guide rib 20 projects in the direction of the container base 21 of the storage container 6; the guide rib 20 is guided in a groove (not shown here) in the container base 21 of the storage container 6. The guide rib 20, which is guided in a movable manner in the groove, ensures that the refill unit 5 is arranged in a correctly positioned manner in relation to the wall holder 2 over the entire pivoting path of the refill unit 5.

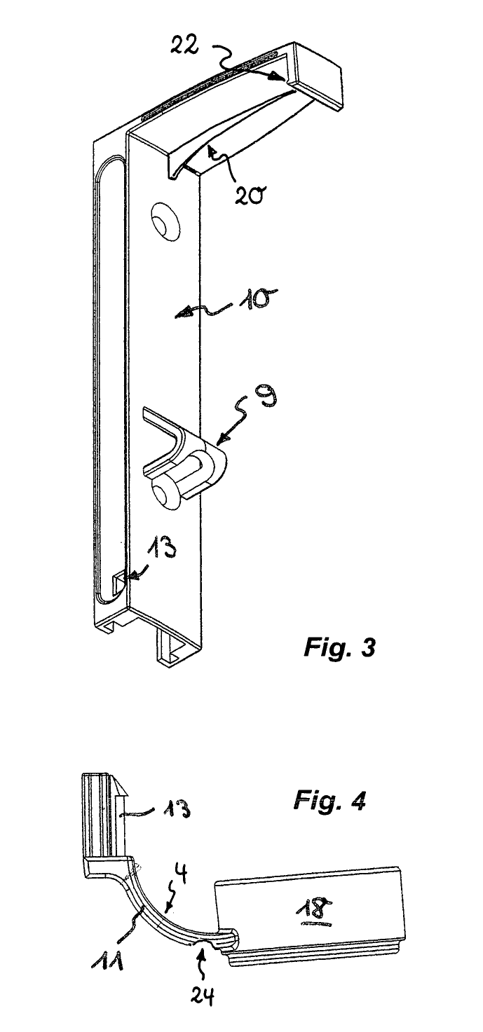

It is clear from FIGS. 3 and 4 that the holder 2 has two holder sub-regions 10, 11, each carrying one of the retaining arms 3, 4. Whereas the retaining arm 4, which is shown in FIG. 4, is retained in a releasable manner on a sub-region 10 of the wall holder 2 which can be mounted at a fixed location on the wall, and is secured thereon by means of an anti-theft device 12, the upper retaining arm 3 here is provided on the wall-mounted sub-region 10.

It can be seen in FIG. 3 that the free end region of the retaining arm 3 is of 1-shaped design and engages over the container base 20 of the storage container 6. The free end region of the retaining arm 3 here engages in a recess 23 of the storage container 6 in the corner region between the container base 21 and the visible container wall. The free end of the retaining arm 3 has provided on it a crosspiece 22, or similar protrusion, which projects in the direction of the storage container 6, subjects the storage container 6 to pressure and prevents the refill unit 5 from rattling in the wall holder 2.

In addition, or instead, it is also possible to provide an anti-theft device on the upper retaining arm 3, this device securing the refill unit 5 in the wall holder 2. It is thus possible, for example, for the upper retaining arm 3 to be retained in a movable manner on the wall holder 2 and to realize its movement capability only once the anti-theft device has been disabled.

It can be seen in FIGS. 1 to 4 that the retaining arm 4, which is retained in a movable and/or releasable manner on the wall holder 2, is retained thereon by means of a latching connection 13, which latching connection 13 can be unlatched by means of a release tool, wherein the release tool (not illustrated specifically here) can be positioned on the latching connection 13 through an appropriately shaped plug-through opening in the outer wall of the wall holder. The release tool may be wedge-shaped or of some other appropriate shape, wherein the tip of the release tool can be used to release the latching connection between the retaining arm 4 and the wall holder 2.

FIG. 2 illustrates that the dispensing device has a dispensing valve 14 with a valve body 15, on which a spring clip 16 acts, which spring clip 16 is in close proximity to at least one inner side of the container wall, or butts against the same, such that pressure activation which deforms the container wall can be converted into a longitudinal movement of the valve body 15 from the closing position into the open position of the valve 14. The storage container 6 has a container neck which can be closed by means of a closure cap 17, the retaining arm 4 adjacent to the container neck having an annular sub-region, designed as a retaining sleeve 18, engaging around the same. The dispensing opening 7 is provided in the closure cap 17. Whereas the rod-like valve body 15 has its free rod end acting with sealing action on that peripheral region of the closure cap 17 which surrounds the dispensing opening 7, the valve body 15 in the open position of the valve 14 is raised up from this peripheral region such that the filling medium located in the storage container 6 can flow out through the dispensing opening 7.

The remainder of the fluid in the storage container 6 always collects in the closure cap 17. Since the storage container 6, in the region of its container neck, and the closure cap 17 are produced from a see-through and/or transparent plastics material, the remainder of the contents in the storage container 6 can always be evaluated and assessed, in order for it to be possible for the storage container 6, if required, to be exchanged in good time for a full storage container 6 and/or one filled with some other filling medium.

In the region between the retaining sleeve 18, on the one hand, and its end which acts on the holder sub-region 11, on the other hand, the retaining arm 4 has a cross-sectional weakening which assists the movement capability of the retaining sleeve 18, results in the amount of force to which the refill unit 5 is subjected during the dispensing operation being transmitted to a reduced extent to the wall holder 2 as well, and is formed here by a transverse groove 24 on the underside of the retaining arm 4.

It is clear from a comparison of FIGS. 1 to 5, on the one hand, and of the exemplary embodiment shown in FIG. 6, on the other hand, that it is also possible for refill units 5 which are of different shapes, have different fillings, or are different in some other way, to be inserted into the wall holder 2 of the wall-mounted metering dispenser 1. Whereas the refill unit 5 of the wall-mounted metering dispenser 1 which is shown in FIGS. 1 to 5 has a droplet-form storage container 6, the refill unit 5 of the exemplary embodiment illustrated in FIG. 6 has a triangular storage container.

Since the refill units 5 are retained in a movable, and in particular pivotable, manner in the wall holders 2, and since the refill units 5 can be moved out of their standby position into their actuating position, in which the actuating protrusion 9 acts on the elastic container wall, pressure activation of the storage container 6 on the visible or outer side using the elbow or the back of the hand is sufficient in order to actuate the wall-mounted metering dispenser 1 illustrated here, the actuating protrusion simultaneously bringing about the pressure activation on the side which is directed toward the wall holder 2. Since the situation where germs are transferred during actuation of the wall-mounted metering dispenser 1 illustrated here is thus avoided, the wall-mounted metering dispenser 1 illustrated here is also distinguished by being better accepted by the users in question.

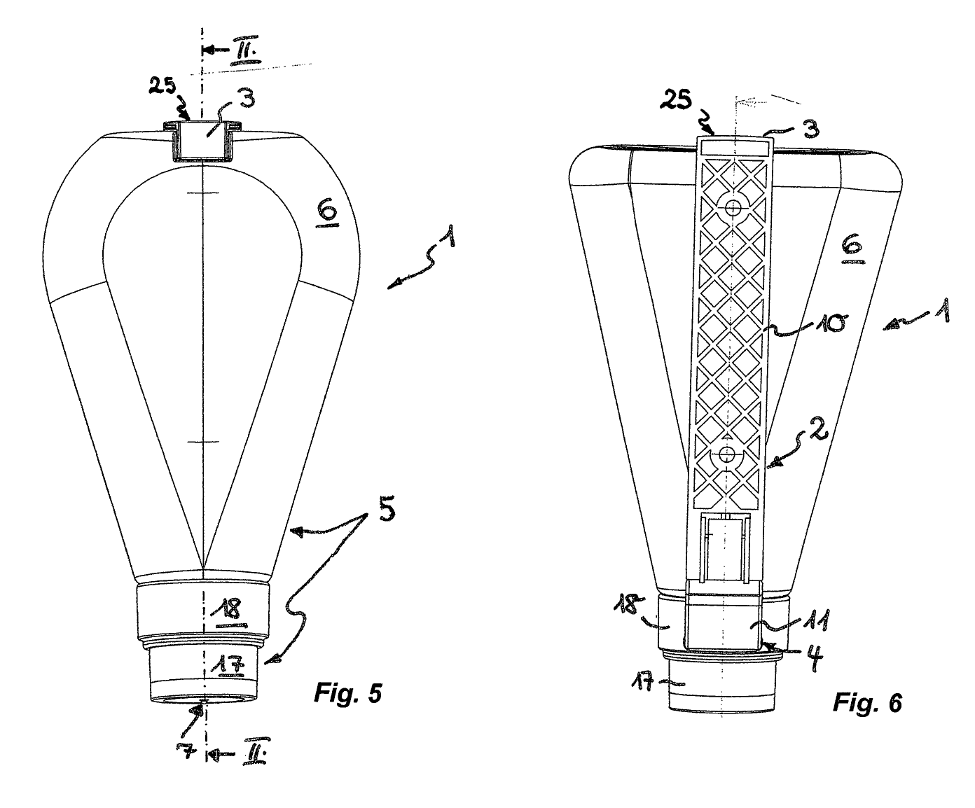

It is indicated in FIGS. 5 and 6 that the retaining arm 3, on its upper side 25, is of roof-like or convex design such that water which comes into contact with the retaining arm 3 can more easily drip off to the sides of the retaining arm 3 and drain off downward from there.

1. A wall-mounted metering dispenser (1) with a wall holder (2), which has two retaining arms (3, 4), between which a refill unit (5) is retained in a releasable manner, said refill unit (5) comprises a storage container (6) and a dispensing device, which has a dispensing opening (7) oriented downward, wherein the retaining arms (3, 4) can be released from one another and/or moved relative to one another between a release position and a retaining position, and wherein the dispensing device can be actuated by pressure activation of the storage container (6), which has at least one sub-region of a container wall produced from elastic material, characterized in that the refill unit (5) is retained in a movable manner in the wall holder (2) and can be moved between a standby position and an actuating position, and in that provided on the wall holder (2) is at least one actuating protrusion (9), which, in the actuating position, acts on the container wall, at least in the elastic sub-region thereof, such that the dispensing device is actuated.

2. The wall-mounted metering dispenser as claimed in claim 1, characterized in that the refill unit (5) is retained in a pivotable manner on at least one of the retaining arms (3).

3. The wall-mounted metering dispenser as claimed in claim 1 or 2, characterized in that at least one of the retaining arms (4) can be moved from a starting position, preferably counter to a restoring force, into an actuating position, in which it is in close proximity to the at least one actuating protrusion (9).

4. The wall-mounted metering dispenser as claimed in one of claims 1 to 3, characterized in that at least one of the retaining arms (4) is retained in a movable and/or releasable manner on a sub-region (10) of the wall holder (2) which is mounted at a fixed location on a wall.

5. The wall-mounted metering dispenser as claimed in one of claims 1 to 4, characterized in that the retaining arm (4), which is retained in a movable and/or releasable manner on the wall holder (2), can be secured thereon by means of an anti-theft device (12).

6. The wall-mounted metering dispenser as claimed in one of claims 1 to 5, characterized in that the retaining arm (4), which is retained in a movable and/or releasable manner on the wall holder (2), is retained thereon by means of a latching connection (13), said latching connection (13) can be unlatched by means of a preferably pin-like release tool, wherein the release tool can be positioned on the latching connection (13) through an appropriately shaped plug-through opening in an outer wall of the wall holder (2).

7. The wall-mounted metering dispenser as claimed in one of claims 1 to 6, characterized in that the dispensing device has a dispensing valve (14) with a valve body (15), on which a spring clip (16) acts, said spring clip (16) is in close proximity to at least one inner side of the container wall, or butts against the same, such that pressure activation which deforms the container wall can be converted into a longitudinal movement of the valve body (15) from a closing position into an open position of the valve (14).

8. The wall-mounted metering dispenser as claimed in one of claims 1 to 7, characterized in that the actuating protrusion (9) acts on the container wall in the region of its outer side which is located opposite the spring clip (16).

9. The wall-mounted metering dispenser as claimed in one of claims 1 to 8, characterized in that the storage container (6) has a container neck which can be closed preferably by means of a closure cap (17), and in that the retaining arm (4) adjacent to the container neck has an appropriately shaped and/or annular sub-region (18) engaging around the same.

10. The wall-mounted metering dispenser as claimed in one of claims 1 to 9, characterized in that the storage container (6), in a region of the container neck, and/or the closure cap (17) are/is produced from a see-through and/or transparent plastic material.
